(19) United States
(12) Patent Application Publication
(10) Pub. No.: US 2014/0094286 A1
(43) Pub. Date: Apr. 3, 2014

(54) Computer Implemented Gaming Support System and Method

(71) Applicant: David Victor Jolliffe, (US)

(72) Inventors: David Victor Jolliffe, Northwood (GB); Steven Paul Jolliffe, Watford (GB)

(21) Appl. No.: 14/044,553

(22) Filed: Oct. 2, 2013

(30) Foreign Application Priority Data
Oct. 2, 2012 (GB) 1217639.2

(51) Int. Cl. G07F 17/32

(52) U.S. Cl. CPC G07F 17/3244
USPC 463/25

(57) ABSTRACT

A computer implemented gaming support system and method are disclosed. A data repository is maintained encoding data on a user's gaming activity and on gaming outcomes. Financial stakes made by the user participating in one or more gaming events are tracked against their outcomes to determine an accumulated financial position in the data repository for said one or more gaming events. If the user's cumulative financial position is a net loss, a proportion of the loss is repaid to the user.

### FIELD OF THE INVENTION

The present invention relates to a computer implemented gaming support system and method that is particularly applicable to gaming and gambling websites.

### BACKGROUND TO THE INVENTION

Gaming or gambling is a past-time that goes back in time further than the concept of money. Today, it is possible to gamble at physical establishments and online (and, for that matter, over the telephone).

There are thousands of web sites that enable customers to gamble. The most popular sites offer casino style games. However, if someone wants to gamble on something from football, horses, financial indexes etc, there is generally a website, casino or bookmaker that will offer it. The most popular casino games are roulette, blackjack, poker, and slot machines.

For the purpose of this application, examples focus on web based casino games. However, it will be appreciated that the principles described can be applied to other games and gambling types and over other media.

Almost all gambling institutions whether online or physical work the same way. The user is playing against the institution and the institution wins because the average payout for every game is controlled so that it is always less than 100%. For example, on a roulette wheel there are usually 37 segments and the odds paid is usually only 35-1 which gives the casino an average margin of about 2.7% for each and every bet placed.

A key issue for the user is that, over time, the vast majority will lose money. This is simply because the odds that are offered are sufficiently low enough to guarantee this is the case. The problem faced by the institution is that it is very expensive to attract a new customer and very difficult to retain them. Billions of dollars are spent on advertising, sponsorship, PR etc to constantly attract new customers.

Obviously, the users are effectively paying the billions of dollars out of their losses. The only effective way to attract new customers for most institutions such as casinos, particularly those operating only online that cannot offer luxury hotel services etc of their physical counterparts, is for the institution to offer a ‘cash bonus’ to new customers.

In an example where an introductory cash bonus is offered, a new user may deposit £100 and in return the institution will give them an extra £100 (or even £200) to gamble with. However, the terms and conditions are written such that it is virtually impossible for the customer to ‘cash out’ either their initial deposit or their ‘bonus’. They are effectively forced to lose all the money they have deposited. Particularly in the online world, the user will move to another online casino and get another ‘introductory bonus’ which is also lost.

Therefore, many users that wish to gamble online are coerced into a raw deal (known as a ‘play-through requirement’) in order to pay the online site's high operating and customer acquisition costs. Many online casinos fail commercially as there are not enough customers to go round.

### STATEMENT OF THE INVENTION

According to an aspect of the present invention, there is provided a computer implemented gaming support system comprising a data repository encoding data on a user's account and on gaming outcomes, a communications interface and a processor, the processor being operable to execute computer program code to receive data on gaming outcomes via the communications interface and execute computer program code that determines a proportion of financial losses associated with said received gaming outcomes associated with the user's account and is operable to cause repayment of said proportion of losses to said user's account.

Embodiments of the present invention seek to provide a system and method to control financial returns associated with gaming. Selected embodiments seek to provide a system and method for determining payment actions and payment action timings of gaming winnings and losses.

The method seeks to give the customer a 100% fair and unbeatable deal that seeks to help eliminate the high customer acquisition costs as the customers will naturally migrate to the best website or physical establishment and stay there.

In selected embodiments, a gaming or gambling institution such as a casino that operates under the stake return system offers a losses payout. In selected embodiments, the system and method provide a ‘Stake return Promise’ in which it is arranged to return, on a fixed date, some of the user's stake should they have cumulative losses on their account. In other words, some of the losses is returned instead of being retained by the institution. The actual amount of losses that will be returned will depend on how many users there are, their gaming/betting patterns and how many winners there are. Preferably, the percentage Stake return is calculated daily and will change regularly. In preferred embodiments, a controller imposes a gradual change to stake return so it does not fluctuate wildly which would seem unfair to customers who are awarded the losses back (Stake return) on the ‘wrong’ day.

What makes this consumer proposition so fair, and unbeatable, is that the casino will return 100% of its winnings, to the customers (ie. 100% of the customer's net losses). As a result, the % of the stake returned will be as high as possible, up to 100%.

In theory, if you have a large number of users gambling on roulette, who all place a large number of bets of a regular size over a long period, all the users will lose some or all of their money. This would result in 100% Stake return so no-one would lose anything.

However, in practice, this will not happen unless a minimum number of bets and the amount of those bets is imposed. This means that there will in practice be winners and losers so it is not likely to be possible to give back 100% of the users' losses even though the casino returns 100% of its winnings.

So, whilst a user may lose, it will be impossible for a user to permanently lose all of their stake. The advantage is that users have a ‘safety net’ of having a significant amount of their losses returned. Preferably, there is no artificial cap on the amount of losses that can be returned. (If higher odds, say, 36-1 were offered on a roulette number, this would be 100% payout on average but it would still be possible to lose 100% of your stake and the experience would potentially be very unsatisfactory). In order to reinforce the fact that it is impossible to lose all your stake, preferably a minimum percentage is returned.

Embodiments of the present invention implement a safety net for users. The safety net is directly proportional to the amount an individual has lost and this is attractive to users. The cash goes directly to those users that need it most. If it was spread in any other way (such as higher odds) than it would not be so fair.

So for example, if over a 3 month period a user loses £500 and the calculated Stake return percentage is 50%, the casino will return 50% of losses and the user would be credited with £250 into his or her account, no strings attached.

In preferred embodiments, stake return from losses is paid back into a user's account after a predetermined period of time. The delay is preferably imposed in order to assist the mechanism to work effectively. The period of time between repayments are preferably approximately monthly, quarterly or annually depending how the Stake return Promise is implemented, which will depend on the number of customers, the number bets, regularity of bets etc.

In preferred embodiments, the user/customer is charged for gaming or gambling. Charging enables an institution to cover overheads and profit whilst enabling possible payback of 100% of the total money staked.

Optionally, the casino or institution may not raise a charge at all or raise a reduced charge by relying on income from site sponsorship or advertising. Alternatively, customers could be charged a membership fee (eg £10 per month or £100 per year). The amount of the fee could depend on the value of their average or maximum bets so that users betting with large stakes pay more than those playing for low stakes. The fee could also be something like 1 cent per chip, or 1 cent per spin or any method the casino chooses. The fees will be clear, transparent and accepted by the customer on sign up.

### BRIEF DESCRIPTION OF THE DRAWINGS

Embodiments of the present invention will now be described by way of example only with reference to the accompanying drawings, in which:

FIG. 1 is a schematic diagram of a gaming support system according to an embodiment of the present invention;

FIG. 2 is a schematic diagram of a gaming system including the gaming support system of FIG. 1; and,

FIG. 3 is a flow chart illustrating steps executed in one embodiment of the present invention.

### THE GAMES

At the start of each game or gaming event, a user offers a monetary sum against a particular outcome. Depending on the rules of the game being played, subsequent monetary sums may be placed on the same game while it is in play. These sums are known as bets.

After the game or gaming event, a gaming engine calculates and pays out any prizes due to the user in dependence on the outcome of the game and on the outcomes against which the bets were placed. These amounts are known as the winnings.

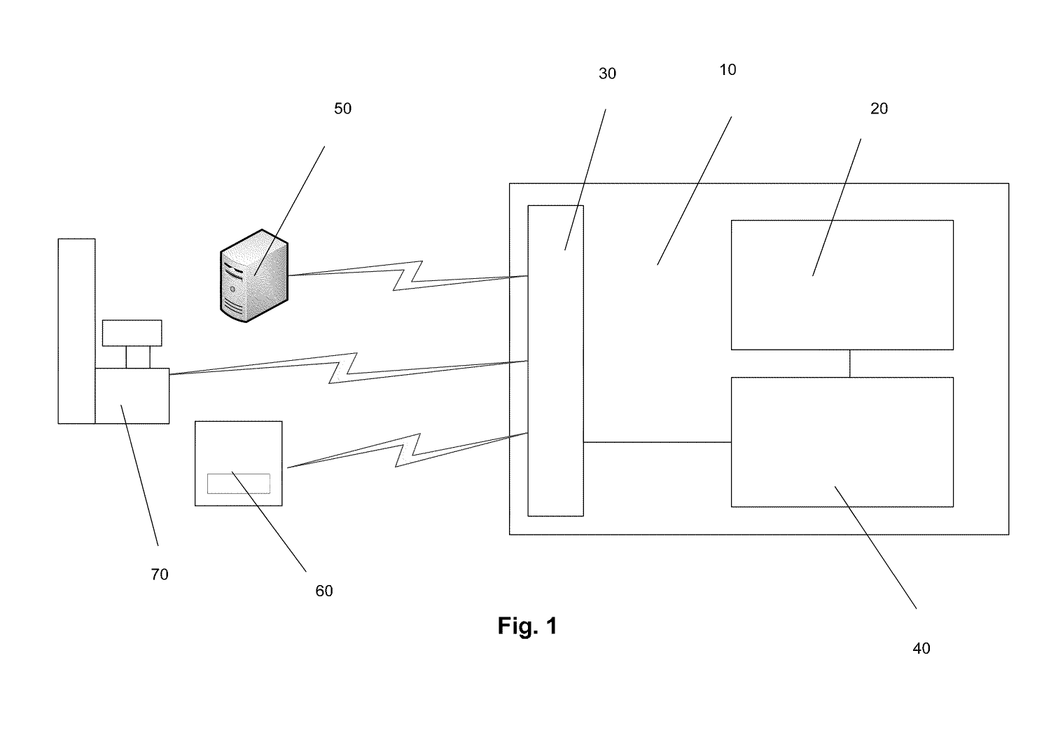

FIG. 1 is a schematic diagram of a gaming support system according to an embodiment of the present invention. The gaming support system 10 includes a data repository 20 encoding data on a user's account and on gaming outcomes, a communications interface 30 and a processor 40.

The processor 40 is operable to execute computer program code to receive data on gaming outcomes via the communications interface 30 and execute computer program code that determines a proportion of financial losses associated with the received gaming outcomes associated with the user's account and is operable to cause repayment of said proportion of losses to said user's account.

The gaming support system may receive data on outcomes from a gaming engine 50, computer program code operating a gaming website 60, an operator of a physical casino 70 or other sources. The gaming support system may be associated with or integrated into a particular system or institution or it may be shared by multiple institutions of systems to enable a user to participate in a variety of sites (possibly online and physical) and accumulate a central stake return. A common stake return may be calculated across multiple games or institutions or else separate stake return may be calculated for individual games or institutions.

The gaming support system 10 preferably keeps track of each user's cumulative total bets, and total winnings in the data repository 20.

If a user's total bets are less than or equal to the same user's total winnings, the user is said to have made a profit, calculated as:

profit=(total winnings−total bets)

If a user's total bets are greater than the same user's total winnings, the user is said to have made a loss, calculated as:

loss=(total bets−total winnings)

Preferably, the gaming support system calculates and causes repayment of a percentage of each user's losses in the form of Stake return payments. These payments are calculated and paid at regular intervals (for example every 3 months after the user joined). This interval needs to be long enough to prevent any large wins from unfairly skewing the data, but short enough so that the user feels it is a reasonable amount of time to wait.

When the Stake return payment for a user is to be calculated, if that user has made a loss overall since joining, then the total amount of that loss qualifies for Stake return:

Stake return qualified=(loss) at time of Stake return payment calculation

The amount of the Stake return awarded will depend on the Stake return percentage, and is preferably calculated as:

Stake return awarded=(Stake return qualified×Stake return percentage)

The difference between the Stake return qualified and the Stake return awarded is retained by the system:

Stake return retained=(Stake return qualified−Stake return awarded)

In its simplest form, the Stake return fund is calculated as:

Stake return fund=(total losses−total profits)

The Stake return percentage is recalculated at regular intervals (for example once per day), and, may be calculated as:

$$Stake return percentage = \frac{Stack return fund}{total losses}$$

When Stake return is awarded to a user, their losses to date are effectively reset to zero. Therefore, the Stake return qualified amount (ie that user's losses to date) is subtracted from the user's total bets for future calculations (and therefore also from the Stake return fund).

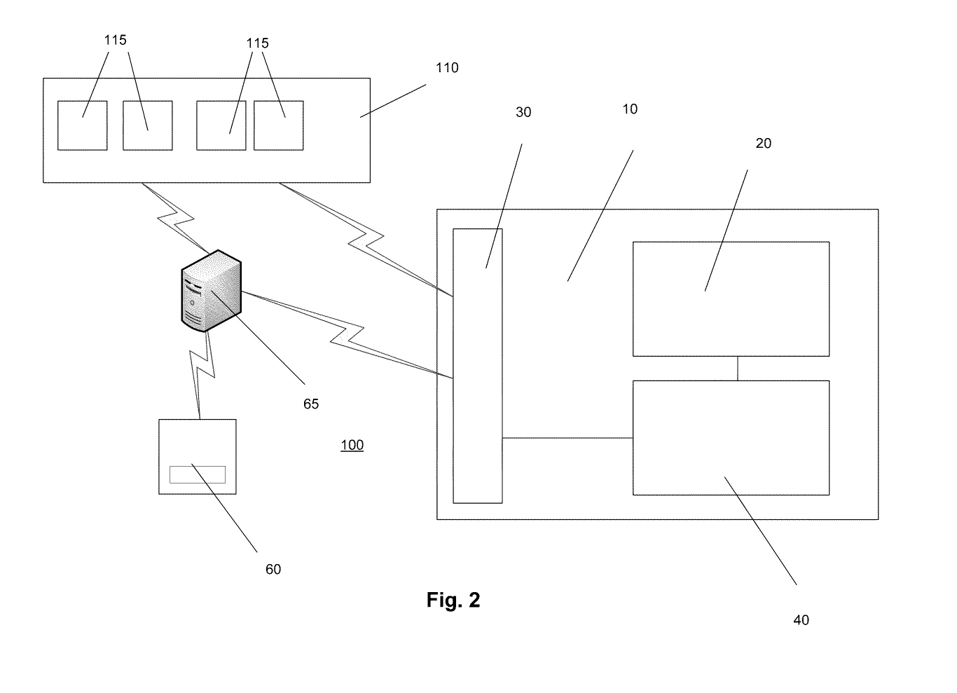

FIG. 2 is a schematic diagram of a gaming system including the gaming support system of FIG. 1.

The gaming system 100 includes server 65 executing a gaming website 60. A user deposits funds in a gaming financial account 110 which is accessible to the gaming website 60 for use in making bets.

Upon the user making a bet at the gaming website 60 and the bet reaching an outcome, data on the outcome is communicated to the financial account 110 (to cause incrementing or decrementing of the account based on win or loss) and also to the gaming support system 10.

The gaming support system maintains, in the data repository, records of profit or loss of individual users and also data on stake return. Periodically, the gaming support system 10 triggers a routine that calculates a stake return amount that is due to the user based on loss over a time period in dependence on the data on the stake return. Upon the support system 10 determining that the user is due a stake return payment, it communicates with the financial account 110 via the communication interface 30 to cause payment to the user's account.

The Stake return retained amount is added back into the Stake return fund.

So the new formulas become:

profit=(total winnings−(total bets−Stake return qualified))

loss=((total bets−Stake return qualified)−total winnings)

Stake return qualified=(loss) at time of Stake return payment calculation

Stake return awarded=(Stake return qualified×Stake return percentage)

Stake return fund=(total losses−total profits)+(total Stake return retained)

$$Stake return percentage = \frac{Stackback fund}{total losses}$$

The Stake return percentage applied when calculating Stake return payments need not be the actual Stake return percentage as stated above. If it were to be applied exactly as calculated, the percentage could vary greatly from day to day, which may be considered unfair by a user.

Therefore, a smoothing algorithm may be applied to the Stake return percentage, changing the definition of Stake return awarded to:

Stake returnback awarded=(Stake return qualified×Smoothed Stake return percentage)

The Smoothed Stake return percentage is calculated by comparing the new Actual Stake return Percentage against the previous Smoothed Stake return Percentage, and adjusting accordingly.

If Actual Stake return percentageₙ<Smoothed Stake returnback percentage₍ₙ₋₁₎, then:

Smoothed Stake return percentageₙ=(Smoothed Stake return percentage₍ₙ₋₁₎−decrease rate)

If Actual Stake return percentageₙ>(Smoothed Stake return percentage₍ₙ₋₁₎+increase rate),

then:

Smoothed Stake return percentageₙ=Smoothed Stake return percentage₍ₙ₋₎+increase rate)

And in any other case:

Smoothed Stake return percentageₙ=Smoothed Stake return percentage₍ₙ₋₁₎

(increase rate and decrease rate are both currently set to 5%, but they may vary from time to time, and need not necessarily be the same as each other)

A threshold may be imposed such that it is not possible for the smoothed Stake return percentage to increase above a maximum level which has been set (for example 100%). In this case, Stake return may be fixed at the maximum level until such time as the actual Stake return percentage drops below the maximum level again.

It may also be possible for the Smoothed Stake return percentage to drop below a minimum level which has been set (for example 50%). In this case, it may be fixed at the minimum level, until such time as the actual Stake return percentage increases to above the minimum level again.

It will be appreciated that the stake return system and method described could be operated by a single institution or as a service to institutions. For example, the gaming support system and financial account may be combined or run by a common entity (or associated parties). In such an arrangement, financial aspects of gaming could be isolated from day to day operation of institutions and remove at least aspects of financial controls where the institutions may otherwise act as banks or similar. Should a gaming website go out of business, the user's funds (and potentially stake return) would in such circumstances be insulated. In one embodiment, funds that could potentially be subject to stake return may be held in a suspense account to ensure its availability for stake returns to the user and a proportion only released to the institution upon determining it is not subject to stake return at the time of stake return payments.

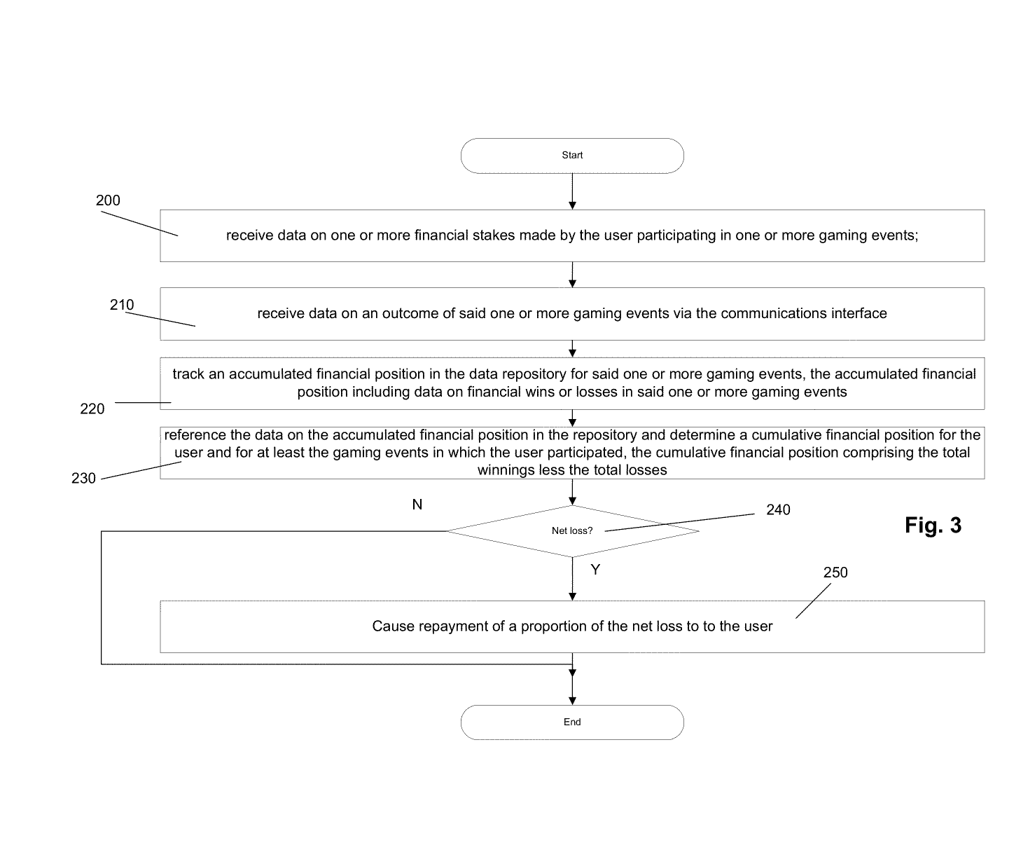

FIG. 3 is a flow chart illustrating steps executed by a gaming support system according to one embodiment. In step 200, data on one or more financial stakes made by the user participating in one or more gaming events is received. In step 210, data on an outcome of said one or more gaming events is received. In step 220, an accumulated financial position is tracked in a data repository for said one or more gaming events, the accumulated financial position including data on financial wins or losses in said one or more gaming events. In step 230, the data on the accumulated financial position in the repository is referenced and a cumulative financial position for the user and for at least the gaming events in which the user participated is determined, the cumulative financial position comprising the total winnings less the total losses. In step 240 if the user's cumulative financial position is a net loss the in step 250 repayment of a proportion of the net loss is caused to the user.

It is to be appreciated that certain embodiments of the invention as discussed below may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the present invention which is defined by the recitations in the claims below and equivalents thereof.

1. A computer implemented gaming support system comprising a data repository encoding data on a user's gaming activity and on gaming outcomes, a communications interface and a processor, wherein the processor is configured to:
i) execute computer program code to receive data on one or more financial stakes made by the user participating in one or more gaming events;
ii) execute computer program code to receive data on an outcome of said one or more gaming events via the communications interface;
iii) execute computer program code that tracks an accumulated financial position in the data repository for said one or more gaming events, the accumulated financial position including data on financial wins or losses in said one or more gaming events;
iv) execute computer program code that references the data on the accumulated financial position in the repository and determines a cumulative financial position for the user and for at least the gaming events in which the user participated, the cumulative financial position comprising the total winnings less the total losses; and,
v) execute computer program code determines if the user's cumulative financial position is a net loss and if so causes repayment of a proportion of the net loss to be repaid to the user.

2. The computer implemented gaming support system of claim 1, further comprising a timer configured to trigger the processor to execute steps iv and v upon expiry of a predetermined time period and, upon execution of step v, cause the processor to execute computer program code to update the data repository to set the user's net losses to zero.

3. The computer implemented gaming support system of claim 1, wherein the processor is further configured to:
execute computer program code to cause display of a user interface to the user on available gaming events;
execute computer program code to receive one or more inputs from a user on stakes to be made in one or more of the available gaming events; and,
execute computer program code to cause the stake to be applied to the gaming event.

4. The computer implemented gaming support system of claim 3, wherein the processor is configured to execute the computer program code to cause the stake to be applied to the gaming event by communicating data via the communications interface on the stake to a remote system hosting the gaming event.

5. The computer implemented gaming support system of claim 4, wherein the processor is configured to assign a unique identifier to the stake and cause said unique identifier to be communicated to the remote system, the remote system being configured communicate the outcome of the gaming event to the processor and being configured to identify said outcome of said gaming event using the unique identifier.

6. The computer implemented gaming support system of claim 1, wherein the processor in step v is configured to execute computer program code to determine an available stake return fund for a period and to calculate said proportion as a percentage determined from the value of the stake return fund.

7. The computer implemented gaming support system of claim 6, wherein the available stake return fund for a period comprises a sum of total losses less total profits for the period.

8. The computer implemented gaming support system of claim 7, wherein the proportion comprises the stake return fund divided by the sum of total losses for the period.

9. The computer implemented gaming support system of claim 7, further comprising a stake return memory, the processor being configured to calculate a daily stake return percentage and store said stake return percentage in the stake return memory, the processor incrementing the previous stake return percentage if the stake return fund divided by the sum of total losses for the period is greater than the previous stake return percentage and decrementing the stake return percentage the stake return fund divided by the sum of total losses for the period is less than the previous stake return percentage and maintaining the stake return percentage otherwise, the processor, on executing step v, being configured to read the stake return percentage from the stake return memory and use said stake return percentage as the percentage.

10. The computer implemented gaming support system of claim 9, wherein said increment comprises an increment of the percentage by 5%.

11. The computer implemented gaming support system of claim 9, wherein said decrement comprises a decrement of the percentage by 5%.

12. A computer implemented gaming support method comprising:
storing, in a data repository, data on a user's account and on gaming outcomes,
receiving data on gaming outcomes via a communications interface;
executing computer program code in a computing device to access said data repository and said data on gaming outcomes to determine financial losses on said gaming outcomes associated with the user's account; and,
causing repayment of said proportion of losses to said user's account.

13. A gaming support system comprising a computer system maintaining a financial account data in a data repository on one or more users and being configured to interface with one or more remote gaming websites, the or each remote gaming website being configured to direct user stake submissions to the gaming support system for deduction against the user's financial account and being further configured to remit winnings from the user's activities on the one or more gaming websites to the user's financial account, wherein the gaming support system includes a processor configured to execute computer program code to periodically calculate a sum of losses less winnings for a user for the period and, upon the sum being a net loss, communicate with the one or more remote gaming websites to obtain a repayment of at least a proportion of said net losses to the user's account.

14. The gaming support system according to claim 13, wherein the processor is configured to execute computer program code to periodically calculate a sum of losses less winnings for a user for the period for each of the one or more remote gaming websites and, for each remote gaming website upon the sum being a net loss, communicate with the respective remote gaming websites to obtain a repayment of at least a proportion of said net loss to the user's account.
